(19) United States
(12) Patent Application Publication
(10) Pub. No.: US 2018/0150884 A1
(43) Pub. Date: May 31, 2018

(54) SUPPLEMENTARY USER PROFILE SERVICE FOR ENCRYPTED INTERNET INTERACTIONS

(71) Applicant: T-Mobile U.S.A., Inc., Bellevue, WA (US)

(72) Inventors: Aaron Drake, Sammamish, WA (US); Brian Ehrhart, Issaquah, WA (US)

(21) Appl. No.: 15/466,459

(22) Filed: Mar. 22, 2017

Related U.S. Application Data
(60) Provisional application No. 62/426,778, filed on Nov. 28, 2016.

(51) Int. Cl. G06Q 30/02; H04W 8/18; H04W 8/22; H04L 29/08; H04L 29/06

(52) U.S. Cl. CPC G06Q 30/0269; H04W 8/18; H04W 8/22; H04L 63/0428; H04L 67/306; H04L 67/18; G06Q 30/0277

(57) ABSTRACT

Targeted electronic advertising media may be provided to users of user devices that access and seek data resources on the Internet through encrypted data streams across a telecommunication network. When an encrypted data stream is received at a cellular telecommunication network server from a user device resident application requesting access to a data resource on the Internet, a user profile token is created for the user device that at least includes the user device identification data to access the cellular telecommunication network. The user profile token may be provided to one or more advertising servers along with data indicative of the requested Internet data resource to enable an advertising server to identify of the user and send targeted advertising media to the requesting user device.

### CROSS REFERENCE TO RELATED PATENT APPLICATION

This application claims priority to U.S. Provisional Patent Application No. 62/426,778, filed on Nov. 28, 2016, entitled “Supplementary User Profile Service for Encrypted Internet Interactions,” which is hereby incorporated by reference in its entirety.

### BACKGROUND

There are numerous Internet computer device architectures that exist to provide custom advertising media to users that are active on the Internet. The computer devices, such as standard computers that access the Internet through wired and wireless connections, and mobile devices that access the Internet across a cellular telecommunication network, may interact with other computer devices for activities such as browsing web pages for content, playing games, downloading media and applications, and logging into web-based services. In each of these interactions, there may be one or more computer devices with access to the Internet that attempt to learn of the identity and/or profile of the user of the accessing device and provide tailored advertising media to be delivered to the accessing device. For example, the one or more computer devices may provide the user with an advertisement on a web page, an in-application ad window, or a pop-up advertisement or other interruptive or interactive media.

Typically, there are several computer devices that may interact across the Internet with each other, through wired or wireless connections, that attempt to identify the user of a device sending data streams across the Internet seeking data resources and provide advertising media to the device based upon knowledge about the user of the device. There may be dedicated computer devices for each of the functions of determining the user of the computer device, determining if advertising media may be sent to the computer device, sending any advertising media, and determining and sending the specific advertising media tailored to the user of the computer device.

However, users at the computer devices may have the data streams for web page requests and other web accesses encrypted such that the detecting servers or other advertising media providers cannot determine the user's device identity making the request. In such instance, the servers cannot provide specifically tailored advertising media to the user device to attempt to optimize the likelihood that the user will be interested in the subject matter of the advertising media. The advertising media sent to the mobile device of the unknown user will typically be generic with a less likelihood of interesting the user.

### BRIEF DESCRIPTION OF THE DRAWINGS

The detailed description is set forth with reference to the accompanying figures.

FIG. 1 is a representative diagram of a user device resident application accessing an Internet data resource through a wireless telecommunication network and the supporting wireless telecommunication network server.

FIG. 2 is a representative diagram of the use of a user profile token being placed in a data resource request from a user device using encrypted data streams on a wireless telecommunication network to request Internet data resources, and send targeted advertising media for display at the user device with the requested data resource.

FIG. 3 is a data flow diagram from the user device through the wireless telecommunication server to the advertising servers and user profile token databases to provide targeted advertising media to the user device for Internet data resources requested by encrypted and unencrypted data streams to the wireless telecommunication server.

FIG. 4 is a flow diagram representing a process for a wireless telecommunication server to place user profile tokens in Internet data resource requests made by user devices using encrypted data streams on the wireless telecommunication network.

### DETAILED DESCRIPTION

Targeted electronic advertising media may be provided to users of user devices that access and seek data resources on the Internet through encrypted data streams across a telecommunication network. When an encrypted data stream is received at a cellular telecommunication network server from a user device resident application requesting access to a data resource on the Internet, a user profile token is created for the user device that at least includes the user device identification data. The user device identification data may enable user device to access the cellular telecommunication network. The user profile token may be provided to one or more advertising servers along with data indicative of the requested Internet data resource. The user profile token and the data indicative of the requested Internet data resources may enable an advertising server to identify of the user and send targeted advertising media to the requesting user device. In various embodiments, the user profile may store information such as location data for the user device requesting resource access, technical information about the requesting user device, a device ID of the requesting user device, information about the user of the requesting user device, and/or so forth.

The use of the user profile tokens may enable advertising servers to provide advertising media to a user even when web page requests and other web access requests from a user device of the user are encrypted data streams that prevents the advertising servers from determining the identity of the user device that originated the requests. Accordingly, the advertising servers may optimize the likelihood that the user will be interested in the subject matter of the advertising media without compromising the security offered by the use of the encrypted data streams to access data resources on the Internet. Example implementations are provided below with reference to the following figures.

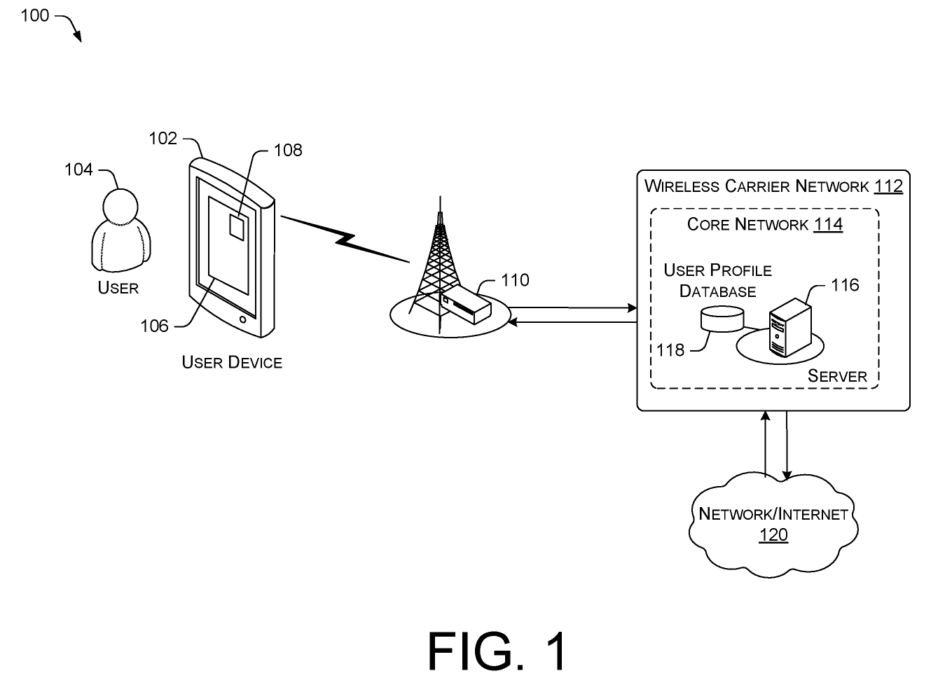

FIG. 1 illustrates a system 100 that provides targeted electronic advertising media 108 to a user 104 of a user device 102 that accesses the Internet 120 through a wireless telecommunication network, such as a wireless carrier network 112. The user device 102 may have a user device resident application 106 that the user 104 is interacting with on the device. The user device resident application 106 may be a game, a web browser for accessing a website, a functional application for online shopping or interaction, a map or navigational software, or any application that executes on the computer platform of the user device 102. The user device 102 may be a feature phone, a smartphone, a tablet computer, a phablet, or any other device that is capable of accessing the Internet 120 through a wireless telecommunication network.

The user device 102 may communicate with a base station 110 in order to interact with a wireless carrier network 112. An example of a wireless carrier network is a commercial carrier in the U.S. and foreign countries, such as T-Mobile®. The core network 114 of the wireless carrier network 112 may include such resources as at least one central server 116 that may route requests for data resources on the Internet 120, and a user profile database 118 that keeps records of the user devices, such as user device 102, that are permitted to access the wireless carrier network 112. Typically, the wireless carrier network 112 is in wired communication with other computer resources to access the Internet 120, but may have wireless communication therewith as well.

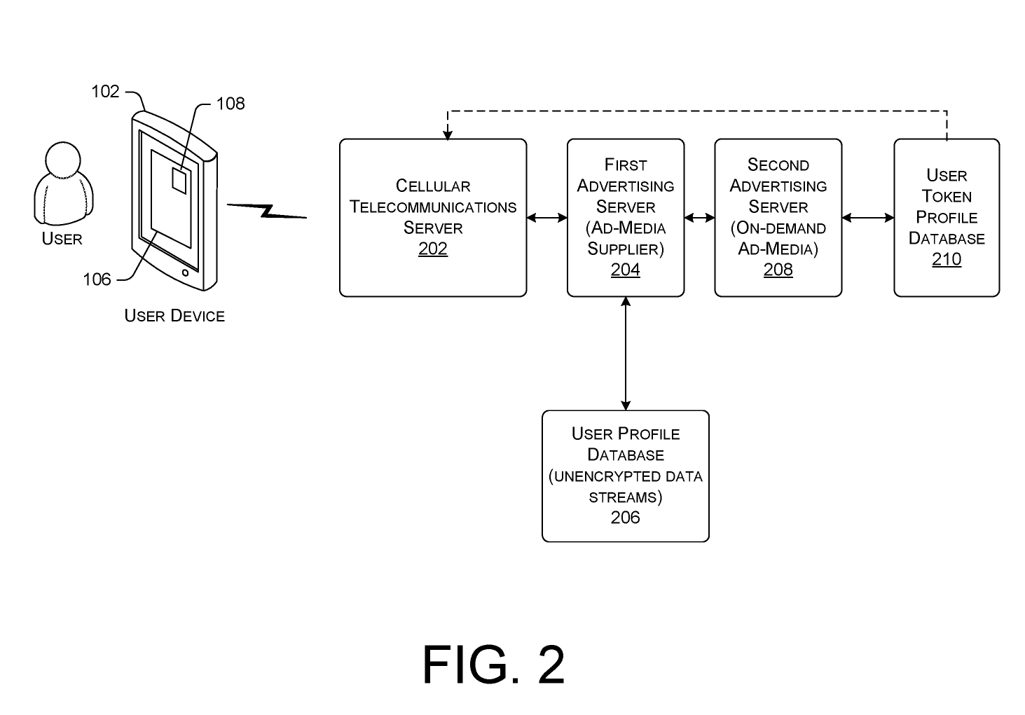

The user device 102 may use open data streams to communicate with the wireless carrier network 112, and thus Internet 120. For example, the user device resident application 106 may make a request for an Internet web page, through a HTTP (“Hypertext Transfer Protocol”) “get header” request which includes information about the requesting computer device. In such instance, the receiving server of the HTTP request may acquire the user information and provide any targeted advertising information, such as targeted advertising media 108, from looking up user identity in a common commercial user database, such as user profile database 206 in FIG. 2. However, the user device 102 may request Internet data resources using encrypted or generic data streams that do not provide information to the Internet data resources about the identity of the user 104 or the user device 102 making the request for the data resource.

The present system 100 thus allows the wireless carrier network 112 to use the information of the user known from the user device 102 to access the wireless telecommunication network, such as a Mobile Identification Number (MIN), Universal Device Identification (UDID) or any of the device identification standards for cellular and PCS technologies, such as EIA/TIA-553 analog, IS-136 TDMA, IS-95 or IS-2000 CDMA. For specific Internet data resource requests from user device resident applications, an Identifier for Advertising (IDFA) is often included in the request and is used to determine targeted advertising media for the user 104 of the user device 102. In one embodiment, the wireless carrier network 112 will create a user profile token that may be comprised of, at least, geographic information (such as cell sector), user device technical information, and device ID, such as a Globally Unique Identifier (GUID) for the user device 102.

In operation, in the embodiment shown in FIG. 2, the cellular telecommunications server 202 (which may be the central server 116 of the core network 114 in FIG. 1) receives a request though a telecommunication network from a resident application 106 of the user device 102 to access a data resource on the Internet (120 in FIG. 1). Then, the cellular telecommunication server 202 may create a user profile token for the user device 102 that is requesting access to an Internet data resource, such as a web page, a game library, navigation data, and the like. The user profile token includes user device identification data to access the telecommunication network (e.g., the wireless carrier network 112 in FIG. 1). The user device identification data may include geographic information (such as cell sector), user device technical information, and device ID, such as a Globally Unique Identifier (GUID).

Subsequently, the cellular telecommunication server 202 may provide the user profile token to at least a first advertising server 204 along with data indicative of the requested data resource such that the user profile token enables the first advertising server 204 to send an advertising media request with the user profile token to one or more second servers. In one configuration, the first advertising server 204 is a general advertising media supplier to a requesting computer devices, such as the user device 102, where the first advertising server 204 determines that the user device resident application 106 has requested an Internet data resource that included a component for placed target advertising media 108 for display to the user 104. The one or more second servers may include an advertising server 208 that selectively provides targeted advertising media for display at the user device 102.

The first advertising server 204 may communicate with several other computer devices to set up the delivery of the targeted advertising media to the user device 102. For example, if the user device 102 has unencrypted data streams for the Internet resource request, with open HTTP header information or a ready IDFA, an existing user profile database 206 may be used to identify the user 104 of the user device 102. However, if the user device 102 is using encrypted data streams or otherwise is not readily providing identifying data to the first advertising server 204, the cellular telecommunication server 202 may send the user profile token to the first advertising server 204. In turn, the first advertising server 204 may then provide the token to other computer devices, in order for the other computing devices to provide the targeted advertising media based on the user profile token.

To create the user profile token, the cellular telecommunication server 202 may, in one embodiment, concatenate a user device user identification, such as the GUID, with mobile customer data known to the cellular telecommunication server 202. The mobile customer data may be obtained from the user profile database 118 in the core network 114 of the wireless carrier network 112. The cellular telecommunication server 202 may be configured to predefine the mobile customer data for creating the user profile token, including predefining user profile data in the user profile database 118. The creation of the user profile token may include incorporating the cellular network customer data based on the information of the wireless telecommunication network server, such as information from the cellular telecommunications server 202. For example, the customer data may include data of the user 104 known to the wireless carrier, such as the identity of the user 104, other applications resident at the user device 102 or other technical data about the user device 102, and the location of the user device 102. Such information may include the specific cell the device is communicating from, prior Internet data resources accessed by the user device 102 (e.g., cookies), and the like.

In at least one embodiment, the cellular telecommunication server may change the user profile token based on a predetermined time of usage to receive targeted advertising media. This allows a limited window of usage by the other computer devices as described here. In other embodiments, the cellular telecommunications server 202 may permit a user 104 to opt out of allowing a user profile token to be created and used, and determine, upon receiving a request for Internet data resource, if the user 104 of the user device 102 requesting access to a data resource has indicated that the user 104 does not want the user profile token created.

In at least one other embodiment, the user 104 at the user device 102 may have the option to not allow the wireless carrier to track the Internet data resource request. In this embodiment, a flag is set within the data request that the user 104 does not desire to be identified (such as using a NULL field on a specific header). In turn, the cellular telecommunication server 202 receiving the request may either not place the user profile token in further requests to the first advertising server 204, or alternatively block all targeted advertising media from being sent back to the user device.

Returning to the first advertising server 204, if the user can be identified by the standard user profile database 206, the first advertising server 204 may send the user profile information to the second advertising server 208 to get specific targeted advertising media for transmission to the user device 102, where the targeted advertising media will be displayed. The second advertising server 208, often called the demand-side media provider, may send the targeted media based upon the specific information about the user 104. If the user profile identification is not possible due to the use of encrypted data stream, then, in this embodiment, the cellular telecommunication server 202 may generate the user profile token and transmit the token along with the request for Internet data resources to the first advertising server 204.

In such embodiments, the cellular telecommunications server 202 may create and send the user profile token along with the Internet data stream request to the first advertising server 204 for identifying the user device 102 and potential the user 104, as if the user 104 is specifically logged into the user device resident application 106. The cellular telecommunications server 202 may also send the user profile token to a user profile token database 210 for storage, in which the tokens may be used to identify corresponding users. The use of a separate user profile token database 210 here is only one embodiment, and one server could accomplish multiple functions as defined herein. In operation, the first advertising server 204 may send a request for target advertising media based upon the Internet data resource request from the user device 102, with the request including the user profile token.

Subsequently, the second advertising server 208 may receive the request along with the user profile token and communicates with the user profile token database 210 to learn of the user 104 and/or user device 102. The user profile token database 210 informs the second advertising server 208 of the user 104 and/or user device 102. The user profile token database 210 may also communicate to the cellular telecommunications server 202 that the user profile token has been used to correspond advertising with a specific request. Such embodiments enable the cellular telecommunications server 202 to monitor the amount of usage of the user profile token and change the token after a predefined period or number of times of use.

Following the second advertising server 208 receiving the user information from the user profile token database, the second advertising server 208 may determine and send targeted advertising media to the first advertising server 204 for relay to the cellular telecommunication server 202. The advertising media may be sent with the targeted advertising media to the user device 102 from the cellular telecommunication server 202 along with the requested Internet data resource. Alternatively, the targeted advertising media (e.g., targeted advertising media 108) may be sent to the user device 102 independently from other Internet data resources for display within the user device resident application 106.

The communications between the servers in FIG. 2 may all be encrypted. Alternatively, at least some of the communications may be encrypted, such as the communications between the cellular telecommunication server 202 and the first advertising server 204. Furthermore, the communications between the servers in FIG. 2 may be exchanged via wired connections, wireless connections, or a combination thereof, and may occur over public or private networks, or the Internet.

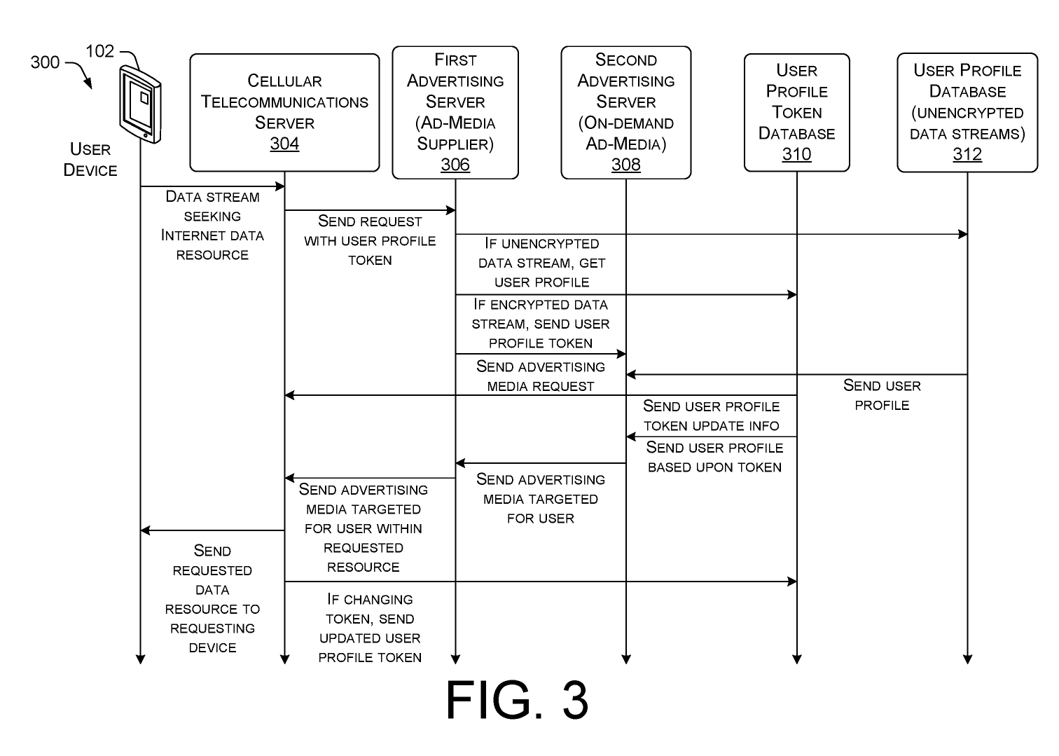

FIG. 3 represents a data flow communication diagram for the user device 302 and servers similar to those show in FIG. 2. In this embodiment, the cellular telecommunication server 304 has a communication portal to the cellular telecommunication network, and the user device 302 may send a data stream to the cellular telecommunication server 304. The cellular telecommunication server 304 may provide an Internet access portal that permits a user 104 of a user device 102 to access data resources on the Internet 120 with one or more user device resident applications, such as the resident application 106. Subsequently, the cellular telecommunications server 304 may send the request for Internet data resources to the first advertising server 306.

If the data stream from the user device 302 is unencrypted, the first advertising server 306 may send a request to the user profile database 312 for the user profile so that the user can be identified for targeted advertising media to be sent to the user of the user device 102. However, if the data stream is encrypted, then the first advertising server 306 may send the user profile token that is provided from the cellular telecommunication server 304 to the user profile token database 310. Such an action may cause the user profile token database 310 to retrieve the user profile for the user profile token. Subsequently, the first advertising server 306 may send an advertising media request to a second advertising server 308 that provided targeted advertising media (e.g., targeted advertising media 108) to user device resident applications 106 in FIG. 1. In such embodiments, the first advertising server 306 may also determine if a user device data stream already includes a user profile token, and if so, selectively modify or remove the token depending upon configuration of the server and/or the preference of the user 104 (FIGS. 1 and 2).

The second advertising server 308 may then receive either the user information from the user profile database 312 for unencrypted data streams or the user information from the user profile token database 310 if the data stream was encrypted from the user device 302. In such embodiments, the user profile token database 310 may also send user profile token update information back to the cellular telecommunication server 304 for use by the server. The cellular telecommunication server 304 may use the token update information to change the token information or become aware that targeted advertising media is arriving for the user device 302.

Following the reception of the user profile data from either the user profile token database 310 or the user profile database 312, the second advertising server 308 may send the targeted advertising media for the identified user to the first advertising server 306 for inclusion into the requested Internet data resources for the user device 302. The first advertising server 306 then relays the targeted-ad media (within or outside of the request data resource) to the cellular telecommunication server 304. In turn, the cellular telecommunication server 304 may relay the targeted advertising media to the requesting user device 302. In such embodiments, the cellular telecommunication server 304 may then change the user profile token and send an update to the user profile token database 310. This may allow the cellular telecommunication carrier to limit the use of user profile tokens by the user profile token database 310, which is useful if the user profile token database 310 is hosted by a third party that is not controlled by the cellular provider.

It is noted that the data flows and responses are monitored such that a “race condition” is not entered between the calls and receipt of the user profile token, targeted advertising media and/or the requested data resource. That is, each request has a specific default to ensure the proper order of execution to get the user profile token to the user profile token database 310, to send the user profile data through the second advertising server 308, to send the targeted advertising media to the first advertising server 306, and then sent to the cellular telecommunication server 304. The user profile token update, if so embodied, also has default settings in the process such that and unintended race condition or wait state is not entered upon a delay in updating.

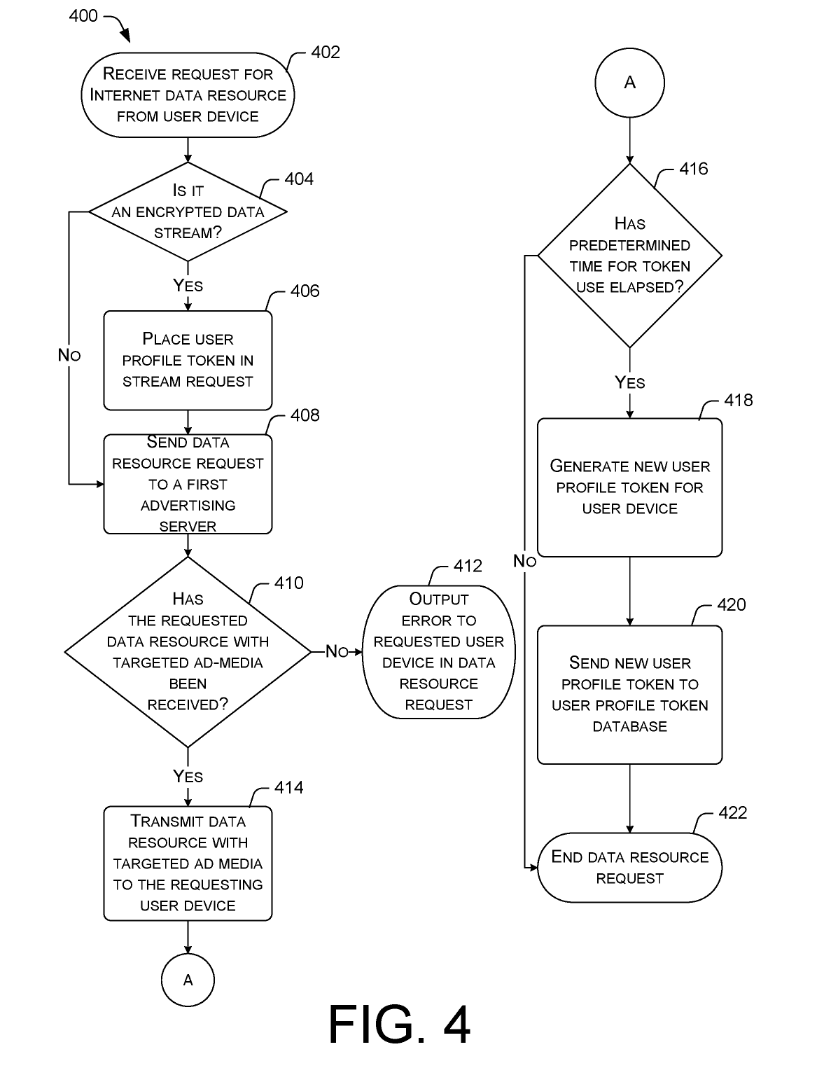

FIG. 4 shows a flow diagram of a process 400 at a wireless telecommunication server, such as the wireless carrier network 112 in FIG. 1, the cellular telecommunication server 202 in FIG. 2, or the cellular telecommunication server 304 in FIG. 3. The process 400 is illustrated as a collection of blocks in a logical flow chart, which represents a sequence of operations that may be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks may be combined in any order and/or in parallel to implement the process.

The process 400 starts from a request being received from a user device 102 for an Internet data resource, such as shown at starter 402. At decisions 404, a determination is then made as to whether the data stream from the user device 102 is encrypted. If the data stream is not encrypted at decision 404, then the data resource request is sent to a first advertising server (e.g., the server 306 in FIG. 3) as shown at step 408. This data stream may contain any requisite user identification data needed to generate targeted advertising media for the user.

However, if the data stream is encrypted at decision 404, then a user profile token is place in the data stream along with the Internet data resource request, as shown at step 406, and then the request is sent to the first advertising server. A determination is then made as to whether the requested data resource with the targeted advertising media has been received at the wireless telecommunication server, as shown at decision 410.

At decision 410, if the request and targeted advertising media has not been received, an error may be outputted to the requesting user device 102 stating that the Internet data resource request has failed, as shown at terminator 412. Otherwise, at step 414, if the request and the targeted advertising media has been received at decision 410, the requested data resource and the targeted advertising media may be sent to the requesting user device 102.

At decision 416, a determination may be made as to whether a predetermined amount of time for use of the specific user profile token has elapsed. If the predetermined amount of time has not elapsed for the use of the user profile token at decision 416, the process 400 may terminate as shown at terminator 422. Otherwise, if the predetermined amount of time for use has elapsed then a new user profile token is generated at step 418, and then the process 400 may proceed to step 420. At step 420, the new user profile token is sent to the user profile token database (e.g., the user profile token database 310 in FIG. 3). The Internet data resource request receipt process then ends at terminator 422.

In at least one embodiment, the user profile token may be generated and stored on accessible databases, such as the user profile token database 210 in FIG. 2 and the user profile token database 310 in FIG. 3, in which the databases are accessible via public networks, private networks, or the Internet. Alternately, a web interface may be provided from the cellular telecommunication server 202 such that authorized computer devices may call into the web access to get user profile data from a specific token. In another embodiment, the user profile token may be placed in the header field in the HTTP header such that a computer device may immediately access the token from the data resource request itself and the token does not need to be sent separately from the data resource request.

In general, the steps and functionality herein may be accomplished through computer hardware, firmware or software components resident on one or more computer devices or as a software asset retrieved by a specific computer device and executed to perform the stated function. In various embodiments, the one or more computing devices may include the user device 102 and the server 116. A software component is a set of computer executable instructions stored together as a discrete whole. Examples of software components include binary executables such as static libraries, dynamically linked libraries, and executable programs. Other examples of software components include interpreted executables that are executed on a run time such as servlets, applets, p-Code binaries, and Java binaries. Software components may run in kernel mode and/or user mode.

Computer-readable media includes, at least, two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

The use of the user profile tokens may enable advertising servers to provide advertising media to a user even when web page requests and other web access requests from a user device of the user are encrypted data streams that prevents the advertising servers from determining the identity of the user device that originated the requests. Accordingly, the advertising servers may optimize the likelihood that the user will be interested in the subject matter of the advertising media without compromising the security offered by the use of the encrypted data streams to access data resources on the Internet.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of providing targeted electronic advertising media to user of a user device accessing Internet through a telecommunication network, comprising:
receiving a request at a telecommunication network server through a telecommunication network from a user device resident application to access a data resource on the Internet;
creating, at the telecommunication network server, a user profile for the user device requesting to access an Internet data resource, the user profile including user device identification data to access the telecommunication network; and
providing the user profile to at least a first advertising server along with data indicative of the data resource, the user profile enabling the first advertising server to send an advertising media request with the user profile to one or more second servers that selectively provide targeted advertising media that is displayable at user devices.

2. The method of claim 1, further comprising sending the advertising media from the telecommunication network server to the user device for display within the user device resident application.

3. The method of claim 1, wherein creating the user profile includes concatenating a user device user identification with mobile customer data.

4. The method of claim 3, further comprising predefining the mobile customer data for creation of the user profile.

5. The method of claim 3, wherein creating the user profile includes incorporating customer data based on information of the telecommunication network server.

6. The method of claim 5, further comprising changing the user profile based on a predetermined time of usage to receive advertising media.

7. The method of claim 1, further comprising encrypting communications between the telecommunication network server and the first advertising server.

8. The method of claim 1, wherein creating a user profile includes creating a token including location data for the user device requesting resource access, technical information about the requesting user device, and information about the user of the user device.

9. The method of claim 1, further comprising determining if the user of the user device requesting access to a data resource has indicated that the user does not want the user profile created.

10. A system, comprising:
a communication portal to a wireless telecommunication network;
an internet access portal that permits a user of a user device to access data resources on the Internet with one or more user device resident applications, wherein the user device resident application is configured to display electronic advertising media or access a website that displays the electronic advertising media to the user of the user device; and
a server that creates a user profile for the user device requesting to access an Internet data resource in response to the user device accessing the Internet through encrypted data streams across the wireless telecommunication network, the user profile including user device identification data to access the wireless telecommunication network,
the server to provide the user profile to at least one advertising server along with data indicative of the data resource requested by the user device.

11. The system of claim 10, wherein the server further sends targeted advertising media provided by the at least one advertising server based at least on the user profile and included in the Internet data resource to the user device for display within the user device resident application.

12. The system of claim 10, wherein the server is to further create the user profile by concatenating a user device user identification with mobile customer data.

13. The system of claim 12, wherein the server is to further predefine the mobile customer data for creation of the user profile.

14. The system of claim 10, wherein the server is to further create the user profile includes incorporating customer data based on information of the telecommunication network server.

15. The system of claim 10, wherein the server is to further change the user profile based on a predetermined time of usage.

16. The system of claim 10, wherein the server is to further encrypt the user profile within communications to other computer devices.

17. The system of claim 10, wherein the server is to further create a user profile token including location data for the user device requesting resource access, technical information about the requesting device, and information about the user of the user device, the token being transmittable from the server to other computer devices.

18. The system of claim 17, wherein the server is to further determine if a user device data stream already includes a user profile token and selectively modifies the token.

19. The system of claim 10, wherein the server is to further determine if the user of the user device requesting access to a data resource has indicated that the user does not want a user profile created.

20. One or more non-transitory computer-readable media storing computer-executable instructions that upon execution cause one or more processors to perform acts comprising:
receiving an encrypted data stream at a cellular telecommunication network server through a cellular telecommunication network from a user device resident application to access a data resource from Internet, the data stream including a request for a data resource on the Internet, the cellular telecommunication network server selectively providing access for user devices to the Internet;
at the cellular telecommunication network server, creating a user profile token for the user device requesting to access a data resource, the user profile token including user device identification data to access the cellular telecommunication network; and
providing the user profile token to one or more advertising servers along with data indicative of the requested Internet data resource, the user profile token enabling the one or more advertising servers to send targeted advertising media, based upon the user profile, to the user device that is displayable at the user device.
